(19) United States
(12) Patent Application Publication
(10) Pub. No.: US 2009/0243477 A1
(43) Pub. Date: Oct. 1, 2009

(54) ORGANIC EL DISPLAY DEVICE

(75) Inventors: Ryuji SANETO, Minami-Ashigara-shi (JP); Yukito Saitoh, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/409,841

(22) Filed: Mar. 24, 2009

(30) Foreign Application Priority Data
Mar. 26, 2008 (JP) 2008-081814

(51) Int. Cl. H01J 1/63; B32B 5/16

(52) U.S. Cl. 313/504; 428/323; 428/328

(57) ABSTRACT

An organic EL display device including at least one high-refractive-index layer having a refractive index of 1.6 or higher, and at least one low-refractive-index layer having a refractive index lower than 1.6, wherein the low-refractive-index layer contains high-refractive-index particles having a refractive index of 1.6 or higher, and wherein the high-refractive-index particles are disposed in a region 1.0 time to 1.2 times an average particle diameter of the particles from an interface between the high-refractive-index layer and the low-refractive-index layer, and the average particle diameter is 0.3 μm to 1 μm.

### BACKGROUND OF THE INVENTION

1. Field of the Invention

The present invention relates to an organic electroluminescense (EL) display device which exhibits improved light extraction efficiency and high brightness.

2. Description of the Related Art

Organic EL display devices are self light-emitting display devices and used as, for example, displays and illumination lamps. Organic EL displays have advantageous display performances such as higher visibility than conventional CRTs and LCDs, and no viewing angle dependency; and also, are advantageous in that they can be lighter and thinner. Meanwhile, organic EL illumination lamps can be advantageously lighter and thinner and also, using a flexible substrate, they may have a shape conventional illumination lamps cannot have.

Although organic EL display devices have advantageous features as described above, in general, constituent layers of display devices (including a light-emitting layer) are each higher in refractive index than air. For example, in organic EL display devices, organic thin film layers (e.g., a light-emitting layer) have a refractive index of 1.6 to 2.1. Thus, emitted light tends to be totally reflected at interfaces, resulting in that light extraction efficiency becomes lower than 20%; i.e., leading to considerable light loss.

With reference to FIG. 1, next will be described light loss observed in such organic EL display devices.

Basically, organic EL display devices have a layer structure as shown in FIG. 1 in which a back electrode 2, an organic layer 3 composed of two or three layers including a light-emitting layer, a transparent electrode 4 and a transparent substrate 5 are laid on a TFT substrate 1. In this structure, holes injected from the back electrode 2 and electrons injected from the transparent electrode 4 are recombined each other in the organic layer 3 to excite, for example, fluorescent compounds for light emission. Then, light generated from the organic layer 3 is emitted directly from the transparent substrate 5 or emitted therefrom after reflection at the back electrode 2 made, for example, of aluminum.

However, as shown in FIG. 1, light generated inside display devices is totally reflected depending on the incident angle of the light at the interface between the organic layer and the neighboring layer which have different refractive indices. Thus, the light is guided inside the display devices and cannot be extracted to the outside (lights indicated by Lb and Lc in FIG. 1). The quantity of the light guided depends on the relative refractive index of the organic layer to the neighboring layer. In the case of commonly used organic EL display devices (air (n=1.0)/transparent substrate (n=1.5)/transparent electrode (n=2.0)/organic layer (n=1.7)/back electrode), the quantity of the light guided inside the display devices without being emitted to the outside (air) accounts for 81%. In other words, only 19% of the total quantity of light emitted can be effectively utilized.

Thus, the following measures must be taken for increasing the light extraction efficiency of the devices: (1) light indicated by Lb shown in FIG. 1 is extracted, which light is totally reflected at the interface between the transparent substrate and air and guided in layers of the organic layer, transparent electrode and transparent substrate and (2) light indicated by Lc shown in FIG. 1 is extracted, which light is totally reflected at the interface between the transparent electrode and the transparent substrate and guided in layers of the organic layer and transparent electrode.

Regarding the above measure (1), U.S. Pat. No. 4,774,435 proposes that a concavo-convex pattern is formed in a surface of a transparent substrate to prevent total reflection at the interface between the transparent substrate and air.

Meanwhile, regarding the above (2), Japanese Patent Application Laid-Open (JP-A) Nos. 11-283751 and 2002-313554 propose that the interface between a transparent electrode and a transparent substrate or between a light-emitting layer and the neighboring layer is processed to have a diffraction grating. In addition, JP-A No. 2002-313567 proposes that a concavo-convex pattern is formed in the interface between laminated organic layers to increase the light extraction efficiency. In the above method in which the interface between a light-emitting layer and the neighboring layer is processed to have a diffraction grating, the neighboring layer is made of a conductive medium, and the depth of concave portions of the diffraction grating is about 40% the thickness of the light-emitting layer. This method extracts the guided light through the interface having a concavo-convex pattern with a specific pitch and a specific depth. Also, in the above method in which a concavo-convex pattern is formed in the interface between laminated organic layers, the layers sandwiching the interface having a concavo-convex pattern are made of a conductive medium, and the concavo-convex pattern has concave portions with a depth of about 20% the thickness of the light-emitting layer and has a tilt angle of about 30° at the interface. As a result, the bonded interface between the organic layers becomes large to increase the light extraction efficiency.

But, the above methods pose problems in that, for example, intricate processing is required and insulation breakdown tends to occur during application of electric current. Thus, in order to produce high-performance organic EL display devices, demand has arisen for further improvement in light extraction.

In order to solve these problems, one proposed means is that a light scattering layer is provided on the surface of a surface-emitting organic EL device to improve the light extraction efficiency (see JP-A Nos. 2003-109747 and 2003-173877, and U.S. Patent Application Publication No. 2009-0015142). In this means, light scattering on the surface involves large light bleeding, resulting in problematic degradation of resolution.

Meanwhile, another proposed means is that a light scattering layer is provided directly on an upper electrode to improve the light extraction efficiency and reduce the occurrence of image blur (see JP-A No. 2006-107744).

This means uses a light scattering layer containing a base material having a refractive index of 1.5 to 1.6, which refractive index is not suitable for effectively extract light guided in the organic layer and transparent electrode.

### BRIEF SUMMARY OF THE INVENTION

An object of the present invention is to provide an organic EL display device which exhibits improved light extraction efficiency and high brightness as a result of preventing total reflection occurring inside organic EL devices, to thereby extract light confined in the organic light-emitting layer to the outside.

Means for solving the problems pertinent in the art are as follows.

<1 > An organic EL display device including:

at least one high-refractive-index layer having a refractive index of 1.6 or higher, and

at least one low-refractive-index layer having a refractive index lower than 1.6,

wherein the low-refractive-index layer includes high-refractive-index particles having a refractive index of 1.6 or higher, and

wherein the high-refractive-index particles are disposed in a region 1.0 time to 1.2 times an average particle diameter of the particles from an interface between the high-refractive-index layer and the low-refractive-index layer, and the average particle diameter is 0.3 μm to 1 μm.

<2> The organic EL display device according to <1> above, wherein the at least one low-refractive-index layer has a refractive index of 1.45 or lower.

<3> The organic EL display device according to <1> above, wherein the at least one high-refractive-index layer is at least one selected from an anode, a cathode, a light-emitting layer, a barrier layer and a high-refractive-index buffer layer.

<4> The organic EL display device according to <1> above, wherein the at least one low-refractive-index layer is at least one selected from a light scattering layer, an adhesion layer, a color filter, a glass substrate, a low-refractive-index buffer layer and an overcoat layer.

<5> The organic EL display device according to <3> above, wherein the at least one high-refractive-index layer includes the anode, the light-emitting layer, the cathode and the barrier layer, and the at least one low-refractive-index layer includes a light scattering layer and a low-refractive-index buffer layer, wherein the light-emitting layer, the cathode, the barrier layer, the light scattering layer and the low-refractive-index buffer layer are laid on the anode in this order, and wherein the light scattering layer includes high-refractive-index particles having a refractive index of 1.6 or higher, and the high-refractive-index particles are in contact with or disposed proximately to an interface between the barrier layer and the light scattering layer.

<6> The organic EL display device according to <3> above, wherein the at least one high-refractive-index layer includes the anode, the light-emitting layer, the cathode, the barrier layer and the high-refractive-index buffer layer, and the at least one low-refractive-index layer includes a light scattering layer, wherein the light-emitting layer, the cathode, the barrier layer, the high-refractive-index buffer layer and the light scattering layer are laid on the anode in this order, and wherein the light scattering layer includes high-refractive-index particles having a refractive index of 1.6 or higher, and the high-refractive-index particles are in contact with or disposed proximately to an interface between the high-refractive-index buffer layer and the light scattering layer.

<7> The organic EL display device according to <5> above, wherein the light scattering layer has a thickness 1 time to 1.2 times an average particle diameter of the high-refractive-index particles.

<8> The organic EL display device according to <1> above, wherein the high-refractive-index particles are at least one inorganic particles selected from TiO₂, ZrO₂, ZnO and SnO₂.

According to the present invention, high-refractive-index particles disposed in the vicinity of the interface can scatter evanescent waves that leak into the low-refractive-index layer during total reflection, resulting in preventing total reflection occurring inside organic EL devices. Thus, the present invention can provide an organic EL display device which exhibits improved light extraction efficiency and high brightness. Furthermore, when a low-refractive-index material is used as a matrix surrounding the particles, the critical angle of total reflection occurring on the interface exposed to air can be large, leading to further improvement in light extraction efficiency.

### BRIEF DESCRIPTION OF THE DRAWINGS

FIG. 1 is an explanatory view of a self light-emitting display device, which is used for describing the reason why the light extraction efficiency decreases.

FIG. 2 illustrates an exemplary layer structure of an organic EL display device of the present invention.

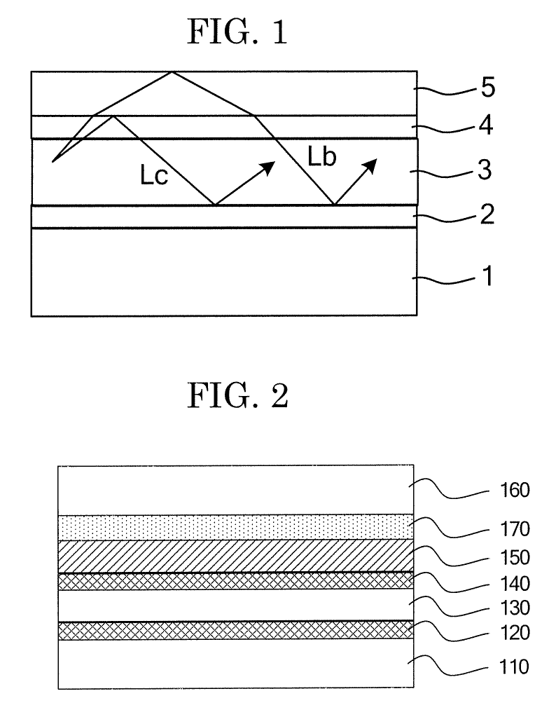

### DETAILED DESCRIPTION OF THE INVENTION

Next will be described in detail an organic EL display device of the present invention. The following description in relation to essential components thereof is based on a typical embodiment of the present invention, which should not be construed as limiting the present invention thereto. Notably, in this specification, the phrase “A to B” (wherein each of A and B is a number) means “A to B inclusive.” That is, the range of A to B includes A as the lower limit and B as the upper limit.

### (Organic EL Display Device)

An organic EL display device of the present invention includes at least one high-refractive-index layer having a refractive index of 1.6 or higher and at least one low-refractive-index layer having a refractive index lower than 1.6; and, if necessary, includes other members.

In the present invention, the low-refractive-index layer contains high-refractive-index particles having a refractive index of 1.6 or higher, and the high-refractive-index particles are disposed in a region 1.0 time to 1.2 times the average particle diameter from the interface. When the high-refractive-index particles are disposed in a region more than 1.2 times the average particle diameter from the interface, refractive index distribution on the low-refractive-index layer side of the interface is averaged to less scatter evanescent light generated. As a result, the effect of improving light extraction efficiency may be reduced.

The expression “high-refractive-index particles are disposed in a region 1.0 time to 1.2 times the average particle diameter from the interface” has the same meaning as the following expression “high-refractive-index particles are in contact with or disposed proximately to the interface between the high-refractive-index-layer and the low-refractive-index-layer.”

The state expressed by the expression “high-refractive-index particles are in contact with or disposed proximately to the interface between the high-refractive-index-layer and the low-refractive-index-layer” is a state where the high-refractive-index particles contained in the low-refractive-index layer are in contact with the interface, a state where the high-refractive-index particles are disposed proximately to the interface without being in contact therewith, or a state where some of the high-refractive-index particles are in contact with the interface and others are disposed proximately to the interface without being in contact therewith.

Also, the state expressed by the expression “high-refractive-index particles are disposed proximately to the interface” is a state where the distance between the interface and the closest point of each of the all particles thereto is greater than 0 times the average particle diameter from the interface and is 0.2 times or less the average particle diameter from the interface.

The state where the high-refractive-index particles are disposed in a region 1.0 time to 1.2 times the average particle diameter from the interface is confirmed through, for example, cross-sectional SEM or cross-sectional TEM. The cross-sectional SEM is a method in which the cross-sectional surface of a broken sample is observed through scanning electron microscopy. The cross-sectional TEM is a method in which the cross-sectional surface of a broken sample is observed through transmission electron microscopy. Specifically, the display surface is broken in a perpendicular direction and observed through electron scanning microscopy. The thus-obtained image can be analyzed to confirm the particle distribution in the low-refractive-index layer.

### <High-Refractive-Index Layer>

The high-refractive-index layer is a layer having a refractive index of 1.6 or higher (preferably 1.6 to 1.8).

Among constituent members of organic EL display devices, an anode, a cathode, an organic light-emitting layer, a hole injection layer, a hole transport layer, an electron injection layer, an electron transport layer, a barrier layer and a high-refractive-index buffer layer are high-refractive-index layers.

### <Low-Refractive-Index Layer>

The low-refractive-index layer is a layer having a refractive index lower than 1.6 (preferably 1.45 or lower, more preferably 1.36 or lower). The refractive index of the low-refractive-index layer may be low to the greatest extent possible, and the lower the refractive index thereof, the higher the light extraction efficiency. This is because, whether or not light scattered in the low-refractive-index layer or on the low-refractive-index layer side of the interface between the low-refractive-index layer and the high-refractive-index layer is confined due to total reflection depends on the refractive index of the low-refractive-index layer, and the light is less confined as the refractive index thereof becomes lower.

Among constituent members of organic EL display devices, a light scattering layer, an adhesion layer, a color filter, a glass substrate, a low-refractive-index buffer layer and an overcoat layer are low-refractive-index layers.

Here, the organic EL display device of the present invention is a display device in which a light-emitting layer or a plurality of thin films made of an organic compound (including a light-emitting layer) are provided between a pair of electrodes (i.e., an anode and a cathode) and in which light scattering layers containing high-refractive-index scattering particles are sequentially laid on high-refractive-index layers that confine light. Here, the high-refractive-index particles are in contact with or disposed proximately to the interface between the high-refractive-index layer and the low-refractive-index layer.

In addition to the light-emitting layer, the organic EL display device of the present invention may further contain, for example, a hole injection layer, a hole transport layer, an electron injection layer, an electron transport layer, a protective layer and a display surface layer. Each of the layers may have other functions in addition to its intrinsic function, and may be formed from various materials.

Also, for realizing high-definition displays, an organic EL device may be used together with a switching device such as a thin film transistor (TFT). The mode in which the organic EL device and switching device are used in combination is called an active matrix-type drive mode. In this mode, the switching device (e.g., a thin film transistor) which controls the drive voltage applied to the organic EL device is formed between the substrate and the organic EL device. Organic EL displays having the configuration where light emitted from an organic EL device is extracted on the switching device side are called bottom emission-type displays, and those having the configuration where light emitted from an organic EL device is extracted on the opposite side to the switching device side are called top emission-type displays.

The organic EL display device of the present invention is preferably an organic EL display device having the following configuration (1) or (2).

Specifically, the organic EL display device having configuration (1) includes an anode, a light-emitting layer, a cathode, a barrier layer, a light scattering layer and a low-refractive-index buffer layer, the light-emitting layer, the cathode, the barrier layer, the light scattering layer and the low-refractive-index buffer layer being laid on the anode in this order, wherein the light scattering layer contains high-refractive-index particles having a refractive index of 1.6 or higher, and the high-refractive-index particles are in contact with or disposed proximately to the interface between the barrier layer and the light scattering layer.

In this case, the high-refractive-index particles are preferably disposed in a region 1.0 time to 1.2 times the average particle diameter thereof from the interface.

One means for realizing configuration (1) is as follows: a light scattering layer containing a low-refractive-index binder and high-refractive-index particles is formed on a barrier layer of the organic EL display device to a thickness almost equal to the average particle diameter of the high-refractive-index particles, and then a low-refractive-index buffer layer is formed thereon from a low-refractive-index binder.

Meanwhile, the organic EL display device having configuration (2) includes an anode, a light-emitting layer, a cathode, a barrier layer, a high-refractive-index buffer layer and a light scattering layer, the light-emitting layer, the cathode, the barrier layer, the high-refractive-index buffer layer and the light scattering layer being laid on the anode in this order, wherein the light scattering layer contains high-refractive-index particles having a refractive index of 1.6 or higher, and the high-refractive-index particles are in contact with or disposed proximately to the interface between the high-refractive-index buffer layer and the light scattering layer.

In this case, the high-refractive-index particles are preferably disposed in a region 1.0 time to 1.2 times the average particle diameter thereof from the interface.

One means for realizing configuration (2) is as follows: a light scattering layer containing a low-refractive-index binder and high-refractive-index particles is formed on a surface of the display substrate which surface is opposite to a light-emitting surface thereof to a thickness almost equal to the average particle diameter thereof; a high-refractive-index buffer layer is formed on the light scattering layer from a high-refractive-index binder; and the thus-produced display substrate, having the light scattering layer and the high-refractive-index buffer layer, is attached to the barrier layer of the organic EL display device.

### <Light Scattering Layer>

The light scattering layer contains a low-refractive-index binder and high-refractive-index particles; and, if necessary, further contains other components.

### —Binder—

The binder used is a resin curable with, among others, a UV ray or an electron beam. That is, the following three resins are used: an ionizing radiation curable resin, a thermosetting resin, and a resin mixture prepared by mixing an ionizing radiation curable resin with a thermoplastic resin and a solvent.

The binder is preferably a polymer having, as a main chain, a saturated hydrocarbon or polyether, more preferably a polymer having a saturated hydrocarbon as a main chain. Also, the binder is preferably in a crosslinked state. The polymer having a saturated hydrocarbon as a main chain is preferably produced through polymerization reaction between ethylenically unsaturated monomers.

For producing a crosslinked binder, a monomer having two or more ethylenically unsaturated groups is preferably used.

Examples of the monomer having two or more ethylenically unsaturated groups include esters formed between polyhydric alcohols and (meth)acrylic acid (e.g., ethylene glycol di(meth)acrylate, 1,4-dichlorohexane diacrylate, pentaerythritol tetra(meth) acrylate, pentaerythritol tri(meth) acrylate, trimethylolpropane tri(meth) acrylate, trimethylolethane tri(meth)acrylate, dipentaerythritol tetra(meth)acrylate, dipentaerythritol penta(meth) acrylate, dipentaerythritol hexa(meth)acrylate, 1,3,5-cyclohexanetriol trimethacrylate, polyurethane polyacrylate and polyester polyacrylate), derivatives of vinylbenzene (e.g., 1,4-divinylbenzene, 4-vinylbenzoic acid-2-acryloyl ethyl ester and 1,4-divinylcyclohexanone), vinyl sulfones (e.g., divinyl sulfone), acrylamides (e.g., methylenebisacrylamide) and methacrylamides. Of these, from the viewpoint of enhancing film hardness; i.e., scratch resistance, (meth)acrylate monomers having at least three functional groups are preferred, and acrylate monomers having at least five functional groups are more preferred. In particular, a commercially available mixture of dipentaerythritol pentaacrylate and dipentaerythritol hexaacrylate is preferably used.

These monomers having ethylenically unsaturated groups can be cured as follows: they are dissolved in a solvent together with various types of polymerization initiator and other additives; the resultant solution is coated and then dried; and the coated product is subjected to polymerization reaction through application of ionizing radiation or heat.

By using crosslinkable functional group-containing monomer in addition to or in place of the monomers having two or more ethylenically unsaturated groups, a crosslinked structure may be introduced into the binder. Examples of the crosslinkable functional group include an isocyanate group, an epoxy group, an aziridine group, an oxazoline group, an aldehyde group, a carbonyl group, a hydrazine group, a carboxyl group, a methylol group and an active methylene group. Also, vinylsulfonic acids, acid anhydrides, cyanoacrylate derivatives, melamine, etherified methylols, esters and urethanes, and metal alkoxides (e.g., tetramethoxysilane) can be used as a monomer for introducing a crosslinked structure. Functional groups which exhibit a crosslinking property as a result of decomposition reaction (e.g., a blocked isocyanate group) may also be used. That is, the crosslinking functional groups employable may exhibit reactivity without any treatments or may exhibit reactivity as a result of decomposition. The binder having these crosslinkable functional groups can be applied and then heated to form a crosslinked structure.

The binder may contain a high-refractive-index monomer in addition to the polymer. Examples thereof include bis(4-methacryloylthiophenyl)sulfide, vinylnaphthalene, vinylphenyl sulfide and 4-methacryloxyphenyl-4′-methoxyphenyl thioether.

Examples of the solvent include ethers having 3 to 12 carbon atoms, ketones having 3 to 12 carbon atoms, esters having 3 to 12 carbon atoms, organic solvents having two or more different functional groups, methanol, ethanol, 1-propanol, 2-propanol, 1-butanol, 2-butanol, tert-butanol, 1-pentanol, 2-methyl-2-butanol, cyclohexanol, isobutyl acetate, methyl isobutyl ketone, 2-octanone, 2-pentanone, 2-hexanone, 2-heptanone, 3-pentanone, 3-heptanone and 4-heptanone. These may be used alone or in combination.

Examples of the ethers having 3 to 12 carbon atoms include dibutyl ether, dimethoxymethane, dimethoxyethane, diethoxyethane, propylene oxide, 1,4-dioxane, 1,3-dioxolan, 1,3,5-trioxane, tetrahydrofuran, anisole and phenetole.

Examples of the ketones having 3 to 12 carbon atoms include acetone, methyl ethyl ketone, diethyl ketone, dipropyl ketone, diisobutyl ketone, cyclopentanone, cyclohexanone and methyl cyclohexanone.

Examples of the esters having 3 to 12 carbon atoms include ethyl formate, propyl formate, n-pentyl formate, methyl acetate, ethyl acetate, methyl propionate, ethyl propionate, n-pentyl acetate and y-butyrolactone.

Examples of the organic solvents having two or more different functional groups include 2-methoxymethyl acetate, 2-ethoxymethyl acetate, 2-ethoxyethyl acetate, 2-ethoxyethyl propionate, 2-methoxyethanol, 2-propoxyethanol, 2-butoxyethanol, 1,2-diacetoxyacetone, acetylacetone, diacetone alcohol, methyl acetoacetate and ethyl acetoacetate. These may be used alone or in combination.

The composition for the light scattering layer is applied with a bar coater or spin coater onto a barrier layer or cathode of the organic EL display device.

The ionizing radiation curable resin composition serving as the binder can be cured by a commonly used curing method; i.e., by irradiating the composition with an electron beam or a UV ray.

Curing with an electron beam can be carried out through application of, for example, an electron beam having an energy of 50 keV to 1,000 keV, preferably 100 keV to 300 keV, which is emitted from various electron beam accelerators such as CockroftWalton type accelerators, Van de Graaff type accelerators, resonance transformer type accelerators, insulating core transformer type accelerators, linear accelerators, dynamitron accelerators and high-frequency accelerators. Meanwhile, curing with a UV ray can be carried out through application of, for example, a UV ray emitted from light sources such as extra-high pressure mercury lamps, high-pressure mercury lamps, low-pressure mercury lamps, carbon arc lamps, xenon arc lamps and metal halide lamps.

In addition to the above materials, the binder may contain, for example, ultra fine metal oxide particles having a high refractive index. The high-refractive-index ultra fine metal oxide particles preferably contain microparticles with a particle diameter of 100 nm or smaller, more preferably 50 nm or smaller, which are made of oxides of at least one metal selected from zirconium, titanium, aluminum, indium, zinc, tin and antimony.

The ultra fine metal oxide particles having a high refractive index is preferably ultra fine particles of the oxide of at least one metal selected from Al, Zr, Zn, Ti, In and Sn. Specific examples of the metal oxides include ZrO₂, TiO₂, Al₂O₃, In₂O₃, ZnO, SnO₂, Sb₂O₃ and ITO, with ZrO₂ being particularly preferred. The amount of the high-refractive-index monomer or the metal oxide ultra fine particles is preferably 10% by mass to 90% by mass, more preferably 20% by mass to 80% by mass, with respect to the total mass of the binder.

In addition to the above materials, the binder may contain, for example, ultra fine particles having a low refractive index. For example, the low-refractive-index ultra fine particles preferably contain silica microparticles having a particle diameter of 100 nm or smaller, more preferably 50 nm or smaller. Alternatively, there may be used hollow silica particles which contain air in each particle and thus exhibit low refractive index. The amount of the low-refractive-index ultra fine particles is preferably 10% by mass to 90% by mass, more preferably 20% by mass to 80% by mass, based on the total amount of the binder.

The thickness of the light scattering layer is preferably 1 time to 1.2 times the average particle diameter of the high-refractive-index particles contained in the light scattering layer. When the light scattering layer has such a thickness, the particles in the vicinity of the interface can scatter evanescent light that leaks into the low-refractive-index layer during total reflection occurring in the high-refractive-index layer, leading to improvement in light extraction efficiency. When the thickness of the light scattering layer is more than 1.2 times the average particle diameter of the high-refractive-index particles contained in the light scattering layer, the number of particles being in contact with the interface is decreased. As a result, the amount of light scattered is decreased, potentially leading to reduction in light extraction efficiency. Also, when the particles are gathered too densely in the vicinity of the interface, the layer formed of densely gathered particles (high-refractive-index layer) has an averaged refractive index distribution. As a result, the particles less scatter evanescent light that leaks into the light scattering layer to potentially reduce light extraction efficiency.

The refractive index of the light scattering layer is 1.6 or lower which is determined through measurement of a sample containing no high-refractive-index particles. When the refractive index is 1.6 or higher, the difference in refractive index becomes small between the light scattering layer and particles. As a result, light scattering effects are reduced, not attaining improved light extraction efficiency.

The refractive index of the light scattering layer (which is determined through measurement of a sample containing no high-refractive-index particles) can be measured with, for example, a device which determines the refractive index of a sample based on an optical simulation obtained from a reflection spectrum of the sample (e.g., FE-3000 reflective film thickness monitor (product of OTSUKA ELECTRONICS CO., LTD)).

### <High-Refractive-Index Particles>

The high-refractive-index particles are not particularly limited and can be appropriately selected depending on the purpose. They may be organic or inorganic microparticles.

Examples of the organic microparticles include polymethyl methacrylate beads, acrylic-styrene copolymer beads, melamine beads, polycarbonate beads, styrene beads, crosslinked polystyrene beads, polyvinyl chloride beads and benzoguanamine-melamine formaldehyde beads.

Examples of the inorganic microparticles include ZrO₂, TiO₂, Al₂O₃, In₂O₃, ZnO, SnO₂ and Sb₂O₃, with TiO₂, ZrO₂ and SnO₂ being particularly preferred.

The high-refractive-index particles have a refractive index of 1.6 or higher, preferably 1.8 or higher. When the refractive index is lower than 1.6, the difference in refractive index becomes small between the high-refractive-index particles and the binder. As a result, light scattering effects are reduced, not attaining improved light extraction efficiency in some cases. The refractive index of the high-refractive-index particles may be high to the greatest extent possible. When the difference in refractive index is large between the high-refractive-index particles and the binder, a sufficient amount of light can be scattered to improve light extraction efficiency.

The average particle diameter of the high-refractive-index particles is preferably 0.3 μm to 1 μm. When it is smaller than 0.3 μm, light scattering effects are reduced, not attaining improved light extraction efficiency in some cases. When it is larger than 1 μm, a coating liquid containing particles having such an average particle diameter is difficult to evenly apply.

Here, the average particle diameter of the high-refractive-index particles can be measured with, for example, devices employing dynamic light scattering (e.g., Nanotrack UPA-EX150 (product of NIKKISO CO., Ltd.)) or measured through image processing using an electron microscope.

Preferably, the high-refractive-index particles are in contact with or disposed proximately to the interface between the low-refractive-index layer and the high-refractive-index layer, with being arranged in a row. With this arrangement, the particles can scatter evanescent light that leaks into the low-refractive-index layer during total reflection occurring in the high-refractive-index layer, leading to improvement in light extraction efficiency. When the high-refractive-index particles are distributed in a region greater than its average particle diameter (e.g., a region 1.3 times the average particle diameter from the interface), some of the particles are disposed relatively far from the interface and do not scatter the evanescent light, resulting in that light extraction efficiency cannot be improved. Increase in the distribution range of the particles potentially poses problems in that uniformity in coating or smoothness of the interface degrades and also, display performance degrades due to increase in light reflected/scattered.

Regarding the high-refractive-index particle content of the light scattering layer, the filling rate of the layer with the particles is preferably 1.0% by volume to 70% by volume, more preferably 5% by volume to 50% by volume. By adjusting the amount of the particles so as to fall within the above range, uneven refractive-index distribution can be provided on the interface between the low-refractive-index layer and the high-refractive-index layer. As a result, the amount of light scattered can be increased to improve light extraction efficiency.

### —Anode—

The anode supplies holes to, for example, a hole injection layer, a hole transport layer and a light-emitting layer, and is made, for example, of a metal, an alloy, a metal oxide, an electrically conductive compound, or a mixture thereof. The anode is preferably made of a material having a work function of 4 eV or higher. Specific examples thereof include conductive metal oxides such as tin oxide, zinc oxide, indium oxide and indium tin oxide (ITO); metals such as gold, silver, chromium and nickel; mixtures or laminates of these metals and these conductive metal oxides; inorganic conductive compounds such as copper iodide and copper sulfide; organic conductive materials such as polyaniline, polythiophene and polypyrrole; and laminates of these organic conductive materials and ITO, with conductive metal oxides being preferred. In particular, ITO is preferred from the viewpoints of, for example, enhancing productivity, exhibiting high conductivity, and exhibiting desired transparency.

The thickness of the anode is not particularly limited and can be appropriately determined in consideration of a selected material. The thickness is preferably 10 nm to 5 μm, more preferably 50 nm to 1 μm, still more preferably 100 nm to 500 nm.

The anode is generally formed in the form of layer on, for example, a soda-lime glass support, an alkali-free glass support and a transparent resin support. When a support made of glass is used, an alkali-free glass support is preferred since the amount of ions eluted can be reduced. Also, a soda-lime glass support is, in use, preferably subjected to barrier coating using, for example, silica.

The thickness of the support is not particularly limited, so long as its mechanical strength can be sufficiently maintained, and can be appropriately determined depending on the purpose. When a glass support is used, the thickness thereof is preferably 0.2 mm or greater, more preferably 0.7 mm or greater.

The transparent resin support used may be a barrier film. The barrier film is a film having a plastic support and a gas impermeable barrier layer laid on the support. Examples of the barrier film include those produced through vapor deposition of silicon oxide or aluminum oxide (Japanese Patent Application Publication (JP-B) No. 53-12953 and JP-A No. 58-217344), those containing an organic-inorganic hybrid coating layer (JP-A Nos. 2000-323273 and 2004-25732), those containing an inorganic layered compound (JP-A No. 2001-205743), those produced by laminating inorganic materials (JP-A Nos. 2003-206361 and 2006-263989), those produced by alternately laminating an organic layer and an inorganic layer (JP-A No. 2007-30387, U.S. Pat. No. 6413645, “Thin Solid Films” by Affinito et. al. 1996 ed. pp. 290 and 291), and those produced by sequentially laminating an organic layer and an inorganic layer (U.S. Patent Publication Application Laid-Open No. 2004-46497).

The anode is produced by a method selected from various methods in consideration of a selected material. For example, when ITO is used, film formation is performed through an electron beam method, sputtering, resistance heating vapor deposition, a chemical reaction method (e.g., a sol-gel method), application of dispersion of indium tin oxide, etc. The anode can be subjected to washing or other treatments to reduce drive voltage for display devices and/or increasing light-emitting efficiency. For example, an ITO anode is advantageously subjected to a UV-ozone treatment, etc.

### —Cathode—

The cathode supplies electrons to, for example, an electron injection layer, an electron transport layer and a light-emitting layer. The material therefor is selected in consideration of ionization potential, stability, and adhesion to neighboring layers such as an electron injection layer, an electron transport layer and a light-emitting layer. Examples thereof include metals, alloys, metal oxides, electrically conductive compounds, and mixtures thereof. Specific examples include alkali metals (e.g., Li, Na and K) or fluorides thereof, alkaline earth metals (e.g., Mg and Ca) or fluorides thereof, gold, silver, lead, aluminum, sodium-potassium alloys or mixed metals thereof, lithium-aluminum alloys or mixed metals thereof, magnesium-silver alloys or mixed metals thereof, and rare-earth metals (e.g., indium and ytterbium), with materials having a work function of 4 eV or lower being preferred, with aluminum, lithium-aluminum alloys or mixed metals thereof, and magnesium-silver alloys or mixed metals thereof being more preferred.

The thickness of the cathode is not particularly limited and can be appropriately determined in consideration of a selected material. The thickness is preferably 10 nm to 5 μm, more preferably 50 nm to 1 μm, still more preferably 100 nm to 1 μm.

The cathode is produced through, for example, an electron beam method, sputtering, resistance heating vapor deposition, a coating method. In this production, elemental metal may be vapor deposited, or two or more components may be simultaneously vapor deposited. Also, several metals can be simultaneously vapor deposited to form an alloy electrode. Furthermore, an alloy which has been prepared in advance may be vapor deposited.

The anode or cathode preferably has a lower sheet resistance: i.e., several hundreds Ω/ or lower.

The above-described barrier film may be attached to the cathode to prevent gas permeation, and a protective layer may be formed on a surface of a display.

### —Light-Emitting Layer—

The light-emitting layer may be made of any materials, so long as they can make a layer to which holes supplied, during application of an electric field, from an anode, a hole injection layer and/or a hole transport layer can be injected, to which electrons supplied, during application of an electric field, from a cathode, an electron injection layer and/or an electron transport layer can be injected, which can transport injected charges, and in which holes and electrons can be recombined with each other to emit light. Examples thereof include benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, cumarine derivatives, perylene derivatives, perynone derivatives, oxadiazole derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, aromatic dimethylidine compounds, various metal complexes (e.g., metal complexes or rare-earth complexes of 8-quinolinol derivatives) and polymer compounds (e.g., polythiophene, polyphenylene and polyphenylene vinylene).

The thickness of the light-emitting layer is not particularly limited and can be appropriately determined depending on the purpose. It is preferably 1 nm to 5 μm, more preferably 5 nm to 1 μm, still more preferably 10 nm to 500 nm.

The forming method for the light-emitting layer is not particularly limited and can be appropriately selected depending on the purpose. Examples thereof include resistance heating vapor deposition methods, electron beam methods, sputtering, molecular lamination methods, coating methods (e.g., spin coating, casting and dip coating) and the LB method, with resistance heating vapor deposition methods and coating methods being particularly preferred.

### —Hole Injection Layer and Hole Transport Layer—

The hole injection layer and the hole transport layer may be made of any materials, so long as they can make a layer to which holes can be injected from an anode, which can transport holes, or can prevent permeation of electrons injected from a cathode. Examples thereof include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, porphyrin compounds, polysilane compounds, poly(N-vinylcarbazole) derivatives, aniline copolymers, and conductive high-molecular-weight oligomers (e.g., thiophene oiligomers and polythiophene).

The thickness of the hole injection layer or the hole transport layer is not particularly limited and can be appropriately determined depending on the purpose. It is preferably 1 nm to 5 μm, more preferably 5 nm to 1 μm, still more preferably 10 nm to 500 nm. The hole injection layer or the hole transport layer may be a single layer made of one or more of the above materials, or a multi layer composed of layers each being the same or different in composition.

The forming method for the hole injection layer or the hole transport layer may be a vacuum vapor deposition method, the LB method, and a method by coating a solution or dispersion of the above materials in a solvent (e.g., spin coating, casting and dip coating).

In the coating method, the materials may be dissolved or dispersed together with resin components. Examples of the resin components include polyvinyl chlorides, polycarbonates, polystyrenes, polymethyl methacrylates, polybutyl methacrylates, polyesters, polysulfones, polyphenylene oxides, polybutadienes, poly(N-vinylcarbazoles), hydrocarbon resins, ketone resins, phenoxy resins, polyamides, ethyl cellulose, vinyl acetate resins, ABS resins, polyurethanes, melamine resins, unsaturated polyester resins, alkyd resins, epoxy resins and silicone resins.

### —Electron Injection Layer and Electron Transport Layer—

The electron injection layer and the electron transport layer may be made of any materials, so long as they can make a layer which can inject electrons from a cathode, which can transport electrons, or can prevent permeation of holes injected from an anode. Examples thereof include triazole derivatives, oxazole derivatives, oxadiazole derivatives, fluorenone derivatives, anthraquinodimethane derivatives, anthron derivatives, diphenylquinone derivatives, thiopyranedioxide derivatives, carbodiimide derivatives, fluorenylidenemethane derivatives, distyrylpyradine derivatives, heterocyclic tetracarboxylic acid anhydrides (e.g., naphthaleneperylene), phthalocyanine derivatives, metal complexes of 8-quinolinol derivatives, metal phthalocyanines, and metal complexes having, as a ligand, benzoxazole or benzothiazole.

The thickness of the electron injection layer or the electron transport layer is not particularly limited and can be appropriately determined depending on the purpose. It is preferably 1 nm to 5 μm, more preferably 5 nm to 1 μm, still more preferably 10 nm to 500 nm.

The electron injection layer or the electron transport layer may be a single layer made of one or more of the above materials, or a multi layer composed of layers each being the same or different in composition.

The forming method for the electron injection layer or the electron transport layer may be a vacuum vapor deposition method, the LB method, and a method by coating a solution or dispersion of the above materials in a solvent (e.g., spin coating, casting and dip coating). In the coating method, the materials may be dissolved or dispersed together with resin components. The resin components may be the same as exemplified above.

### —Barrier Layer—

The barrier layer is not particularly limited, so long as it can prevent permeation of substances contained in the atmosphere; e.g., oxygen, water, nitrogen oxides, sulfur oxides and ozone, and can be appropriately selected depending on the purpose.

The material for the barrier layer is not particularly limited and can be appropriately selected depending on the purpose. Examples thereof include SiN and SiON.

The thickness of the barrier layer is particularly limited and can be appropriately selected depending on the purpose. It is preferably 5 nm to 1,000 nm, more preferably 7 nm to 750 nm, particularly preferably 10 nm to 500 nm.

When the thickness is smaller than 5 nm, the barrier layer may not exhibit sufficient barrier functions; i.e., may not sufficiently prevent permeation of oxygen and water contained in the atmosphere. Whereas when the thickness is greater than 1,000 nm, the barrier layer may exhibit reduced light transmittance, potentially leading to decrease in transparency.

Regarding optical characteristics of the barrier layer, the light transmittance is preferably 80% or higher, more preferably 85% or higher, still more preferably 90% or higher.

The forming method for the barrier layer is not particularly limited and can be appropriately selected depending on the purpose. Examples thereof include CVD.

The organic EL display device of the present invention exhibits improved light extraction efficiency and high brightness, and is preferably used as a bottom-emission-type or top-emission-type organic EL display device.

### EXAMPLES

The present invention will next be described by way of examples, which should not be construed as limiting the present invention thereto.

### Production Example 1

### <Fabrication of Organic EL Display Device>

A top-emission-type organic EL display device was fabricated in the following manner.

First, a TFT was formed on an insulating substrate via a buffer layer, and then an interlayer insulating film made of SiN was entirely formed thereon through deposition. Subsequently, through commonly-used photo-etching, contact holes were formed so as to reach a source region and a drain region.

Thereafter, an Al/Ti/Al multi-layer conductive layer was entirely formed thereon through deposition, and then patterning was carried out through commonly-used photo-etching so that a drain electrode and a source electrode reached TFT. Note that the source electrode had four branched lines extending from a common source line.

Subsequently, a photosensitive resin was entirely applied thereon through spin coating to form an interlayer conductive film. The thus-formed conductive film was exposed to light using a predetermined mask, and then developed with a predetermined developer, to thereby form contact holes corresponding to the branched lines of the source electrode. Note that, conveniently, contact holes were formed with respect to the common source line.

Thereafter, an Al film was entirely formed thereon through sputtering, and then patterning was carried out through commonly-used photo-etching to form a predetermined pattern, to thereby form segmented anodes connecting through the contact holes with the branched lines of the source electrode.

Subsequently, through mask vapor deposition, an organic EL layer was formed so as to cover the segmented anodes exposed to the bottom portion of pixel apertures. Furthermore, through mask vapor deposition, an Al film having a thickness of 10 nm and an ITO film having a thickness of 30 nm were sequentially formed on the organic EL layer through deposition to form a common cathode. Regions corresponding to the segmented anodes were segmented pixels.

In this case, the organic EL layer 1.30 had a hole injection layer made of 2-TNATA (4,4′,4″-tris(2-naphthylphenylamino)triphenylamine), a hole transport layer made of α-NPD (N,N′-bis(1-naphthy)-N,N′-diphenyl-1,1′-biphenyl-4,4′-diamine, and a light-emitting layer made of Alq3 (8-quinolinol-aluminum complex). Here, the hole injection layer, the hole transport layer and the light-emitting layer are laid on the segmented anodes in this order.

Thereafter, through CVD, SiN and SiON films were sequentially and entirely formed thereon through deposition to form a barrier layer having a thickness of 500 nm.

Thereafter, a light scattering layer 170 was formed on the barrier layer, and then a glass plate 160 serving as a transparent substrate was attached to the light scattering layer.

Through the above procedure, an organic EL display device having a layer structure as shown in FIG. 2 in which the anode 120, the organic EL layer 130, the cathode 140, the barrier layer 150, the light scattering layer 170 and the transparent substrate 160 were laid on the TFT substrate 110.

### Preparation Example 1

### <Preparation of High-Refractive-Index Buffer Layer Coating Liquid 1>

High-refractive-index buffer layer coating liquid 1 having the following composition was prepared.

### —Composition of High-Refractive-Index Buffer Layer Coating Liquid 1—

Zirconia microparticles-containing hardcoat composition liquid (DeSolite Z7404, product of JSR Corp.): 1,000 g
UV curable resin (DPHA, product of NIPPON KAYAKU CO., LTD.): 310 g
Silane coupling agent (KBM-5103, product of Shin-Etsu Chemical Co. Ltd.): 100 g
Methyl ethyl ketone (MEK): 290 g
Methyl isobutyl ketone (MIBK): 130 g

### Preparation Example 2

### <Preparation of Low-Refractive-Index Buffer Layer Coating Liquid 1>

Low-refractive-index buffer layer coating liquid 1 having the following composition was prepared.

### —Composition of Low-Refractive-Index Buffer Layer Coating Liquid 1—

Silica ultra fine particles-containing hardcoat composition (DeSolite Z7526, product of JSR Corp.): 1,000 g
UV curable resin (DPHA, product of NIPPON KAYAKTJ CO., LTD.): 310 g
Silane coupling agent (KBM-5103, product of Shin-Etsu Chemical Co. Ltd.): 100 g
Methyl ethyl ketone (MEK): 290 g
Methyl isobutyl ketone (MIBK): 130 g

### Preparation Example 3

### <Preparation of Light Scattering Layer Coating Liquid 1>

Light scattering layer coating liquid 1 having the following composition was prepared.

### —Composition of Light Scattering Layer Coating Liquid 1—

Silica ultra fine particles-containing hardcoat composition (DeSolite Z7526, product of JSR Corp.): 1,000 g
UV curable resin (DPHA, product of NIPPON KAYAKU CO., LTD.): 310 g
Silane coupling agent (KBM-5103, product of Shin-Etsu Chemical Co. Ltd.): 100 g
Titanium dioxide microparticles (TA-200, refractive index: 2.4 or higher, average particle diameter: 0.39 μm, product of FUJI TITANIUM INDUSTRY CO., LTD.): 850 g
Methyl ethyl ketone (MEK): 290 g
Methyl isobutyl ketone (MIBK): 130 g

The titanium dioxide microparticles (high-refractive-index particles) are known to have a refractive index of 2.4 or higher. Also, the average particle diameter thereof is a number average particle diameter determined through measurement using Nanotrack UPA-EX150 (product of NIKKISO CO., Ltd.).

### Preparation Example 4

### <Preparation of Light Scattering Layer Coating Liquid 2>

### —Preparation of Hard-Coat Layer Coating Liquid—

A hard-coat layer coating liquid was prepared as follows. First, trimethylolpropane triacrylate (TMPTA, product of NIPPON KAYAKU CO., LTD.) (750.0 parts by mass) was added to a mixing tank. Subsequently, poly(glycidyl methacrylate) (average mass molecular weight: 15,000) (270.0 parts by mass), methyl ethyl ketone (730.0 parts by mass), cyclohexanone (500.0 parts by mass), a photopolymerization initiator (Irgacure 184, product of Ciba Speciality Chemicals Inc.) (50.0 parts by mass), and di(t-butylphenyl)iodonium hexafluorophosphate (25.0 parts by mass) were charged into the mixing tank, followed by stirring. Thereafter, the resultant mixture was filtrated with a polypropylene filter having a pore size of 0.4 μm.

### —Preparation of Light Scattering Layer Coating Liquid 2—

The following compositions were mixed with each other to prepare light scattering layer coating liquid 2.
The above-prepared hard-coat layer coating liquid: 1,000 g
Titanium dioxide microparticles (TA-200, refractive index: 2.4 or higher, average particle diameter: 0.39 μm, product of FUJI TITANIUM INDUSTRY CO., LTD.): 1,100 g

The titanium dioxide microparticles (high-refractive-index particles) are known to have a refractive index of 2.4 or higher. Also, the average particle diameter thereof is a number average particle diameter determined through measurement using Nanotrack UPA-EX150 (product of NIKKISO CO., Ltd.).

### Preparation Example 5

### <Preparation of Light Scattering Layer Coating Liquid 3>

### —Preparation of Hard-Coat Layer Coating Liquid—

A hard-coat layer coating liquid was prepared as follows. First, trimethylolpropane triacrylate (TMPTA, product of NIPPON KAYAKIJ CO., LTD.) (750.0 parts by mass) was added to a mixing tank. Subsequently, poly(glycidyl methacrylate) (average mass molecular weight: 15,000) (270.0 parts by mass), methyl ethyl ketone (730.0 parts by mass), cyclohexanone (500.0 parts by mass), a photopolymerization initiator (Irgacure 184, product of Ciba Speciality Chemicals Inc.) (50.0 parts by mass), and di(t-butylphenyl)iodonium hexafluorophosphate (25.0 parts by mass) were charged into the mixing tank, followed by stirring. Thereafter, the resultant mixture was filtrated with a polypropylene filter having a pore size of 0.4 μm.

### —Preparation of Light Scattering Layer Coating Liquid 3—

The following compositions were mixed with each other to prepare light scattering layer coating liquid 3.
The above-prepared hard-coat layer coating liquid: 1,000 g
Titanium dioxide microparticles (TA-500, refractive index: 2.4 or higher, average particle diameter: 0.45 μm, product of FUJI TITANIUM INDUSTRY CO., LTD.): 1,100 g

The titanium dioxide microparticles (high-refractive-index particles) are known to have a refractive index of 2.4 or higher. Also, the average particle diameter thereof is a number average particle diameter determined through measurement using Nanotrack UPA-EX150 (product of NIKKISO CO., Ltd.).

### Preparation Example 6

### <Preparation of Light Scattering Layer Coating Liquid 4>

### —Preparation of Hard-Coat Layer Coating Liquid—

A hard-coat layer coating liquid was prepared as follows. First, trimethylolpropane triacrylate (TMPTA, product of NIPPON KAYAKU CO., LTD.) (750.0 parts by mass) was added to a mixing tank. Subsequently, poly(glycidyl methacrylate) (average mass molecular weight: 15,000) (270.0 parts by mass), methyl ethyl ketone (730.0 parts by mass), cyclohexanone (500.0 parts by mass), a photopolymerization initiator (Irgacure 184, product of Ciba Speciality Chemicals Inc.) (50.0 parts by mass), and di(t-butylphenyl)iodonium hexafluorophosphate (25.0 parts by mass) were charged into the mixing tank, followed by stirring. Thereafter, the resultant mixture was filtrated with a polypropylene filter having a pore size of 0.4 μm.

### —Preparation of Light Scattering Layer Coating Liquid 4—

The following compositions were mixed with each other to prepare light scattering layer coating liquid 4.
The above-prepared hard-coat layer coating liquid: 1,000 g
Titanium dioxide microparticles (TA-700, refractive index: 2.4 or higher, average particle diameter: 1.0 μm, product of FUJI TITANIUM INDUSTRY CO., LTD.): 1,100 g

The titanium dioxide microparticles (high-refractive-index particles) are known to have a refractive index of 2.4 or higher. Also, the average particle diameter thereof is a number average particle diameter determined through measurement using Nanotrack UPA-EX150 (product of NIKKISO CO., Ltd.).

In the following Examples and Comparative Examples, the refractive index of each layer was measured as follows.

### <Measurement of Refractive Index>

A coating liquid for the layer which liquid contains no scattered particles was prepared and then applied onto a glass plate. The thus-applied coating liquid was cured with UV rays and then measured for its refractive index using the FE-3000 reflective film thickness monitor (product of OTSUKA ELECTRONICS CO., LTD).

### Comparative Example 1

### —Fabrication of Organic EL Display Device—

The above-prepared low-refractive-index buffer layer coating liquid 1 was applied onto the barrier layer of the organic EL display device of Production Example 1 to a thickness of 3 μm. After evaporation of the solvent, the thus-applied low-refractive-index buffer layer (refractive index: 1.440) was cured through irradiation of UV rays (illuminance: 400 mW/cm² and irradiation dose: 300 mJ/cm²) using a 160 W/cm air-cooled metal halide lamp (product of EYE GRAPHICS CO., LTD.). Subsequently, a glass substrate having, on one surface thereof, an adhesion layer made of an adhesive was attached to the low-refractive-index buffer layer, to thereby fabricate an organic EL display device of Comparative Example 1.

### Comparative Example 2

### —Fabrication of Organic EL Display Device—

The above-prepared light scattering layer coating liquid 1 was applied onto the barrier layer of the organic EL display device of Production Example 1 to a thickness of 3 μm. After evaporation of the solvent, the thus-applied light scattering layer (refractive index: 1.440, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.). Subsequently, a glass substrate having, on one surface thereof, an adhesion layer made of an adhesive was attached to the light scattering layer, to thereby fabricate an organic EL display device of Comparative Example 2.

### Example 1

### —Fabrication of Organic EL Display Device—

The above-prepared light scattering layer coating liquid 1 was applied onto the barrier layer of the organic EL display device of Production Example 1 to a thickness of 0.39 μm. After evaporation of the solvent, the thus-applied light scattering layer (refractive index: 1.440, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Subsequently, the above-prepared low-refractive-index buffer layer coating liquid 1 was applied onto the light scattering layer to a thickness of 3.0 μm. After evaporation of the solvent, the thus-applied low-refractive-index buffer layer (refractive index: 1.440) was cured through irradiation of UV rays (illuminance: 400 mW/cm² and irradiation dose: 300 mJ/cm²) using a 160 W/cm air-cooled metal halide lamp (product of EYE GRAPHICS CO., LTD.). Thereafter, a glass substrate having, on one surface thereof, an adhesion layer made of an adhesive was attached to the low-refractive-index buffer layer, to thereby fabricate an organic EL display device of Example 1.

Through cross-sectional TEM, it was confirmed that the high-refractive-index particles were in contact with the interface between the light scattering layer and the low-refractive-index buffer layer, with being arranged almost in a row. Also, the filling rate of the light scattering layer with the high-refractive-index particles was found to be 45% by volume.

### Example 2

### —Fabrication of Organic EL Display Device—

The procedure of Example 1 was repeated, except that the light scattering layer coating liquid 1 was applied onto the barrier layer of the organic EL display device to a thickness of 0.46 μm, to thereby fabricate an organic EL display device of Example 2.

Through cross-sectional TEM, it was confirmed that the high-refractive-index particles were disposed almost in a row, and the distance of the interface between the light scattering layer and the low-refractive-index buffer layer from the closest point of each particle to the interface ranged from 0 μm to 0.07 μm. Also, the filling rate of the light scattering layer with the high-refractive-index particles was found to be 45% by volume.

### Comparative Example 3

### —Fabrication of Organic EL Display Device—

The procedure of Example 1 was repeated, except that the light scattering layer coating liquid 1 was applied onto the barrier layer of the organic EL display device to a thickness of 0.49 μm, to thereby fabricate an organic EL display device of Comparative Example 3.

Through cross-sectional TEM, it was confirmed that the distance of the interface between the light scattering layer and the low-refractive-index buffer layer from the closest point of each high-refractive-index particle to the interface ranged from 0 μm to 0.12 μm. Also, the filling rate of the light scattering layer with the high-refractive-index particles was found to be 45% by volume.

### Example 3

### —Fabrication of Organic EL Display Device—

First, a display substrate having a light scattering layer was fabricated. Specifically, the above-prepared light scattering layer coating liquid 1 was applied to a thickness of 0.39 μm onto a surface of a display substrate, the surface being opposite to a light-emitting surface thereof. After evaporation of the solvent, the thus-applied light scattering layer (refractive index: 1.440, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Subsequently, the above-prepared high-refractive-index buffer layer coating liquid 1 was applied onto the light scattering layer to a thickness of 3.0 μm. After evaporation of the solvent, the thus-applied high-refractive-index buffer layer 2 5 (refractive index: 1.620) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Through cross-sectional TEM, it was confirmed that the high-refractive-index particles were in contact with the interface between the light scattering layer and the high-refractive-index buffer layer, with being arranged almost in a row. Also, the filling rate of the light scattering layer with the high-refractive-index particles was found to be 45% by volume.

The thus-fabricated display substrate, having the light scattering layer and the high-refractive-index buffer layer, was made to closely adhere with a roller to the barrier layer of the organic EL display device of Production Example 1, to thereby fabricate an organic EL display device of Example 3.

### Example 4

### —Fabrication of Organic EL Display Device—

The procedure of Example 3 was repeated, except that the light scattering layer coating liquid 1 was applied to a thickness of 0.46 μm onto a surface of a display substrate, the surface being opposite to a light-emitting surface thereof, to thereby fabricate an organic EL display device of Example 4.

Through cross-sectional TEM, it was confirmed that the high-refractive-index particles were disposed almost in a row, and the distance of the interface between the light scattering layer and the low-refractive-index buffer layer from the closest point of each particle to the interface ranged from 0 μm to 0.07 μm. 2o Also, the filling rate of the light scattering layer with the high-refractive-index particles was found to be 45% by volume.

### Comparative Example 4

### —Fabrication of Organic EL Display Device—

The procedure of Example 3 was repeated, except that the light scattering layer coating liquid 1 was applied to a thickness of 0.49 μm onto a surface of a display substrate, the surface being opposite to a light-emitting surface thereof, to thereby fabricate an organic EL display device of Comparative Example 4.

Through cross-sectional TEM, it was confirmed that the distance of the interface between the light scattering layer and the high-refractive-index buffer layer from the closest point of each high-refractive-index particle to the interface ranged from 0 μm to 0.12 μm. Also, the filling rate of the light scattering layer with the high-refractive-index particles was found to be 45% by volume.

### Example 5

### —Fabrication of Organic EL Display Device—

First, a display substrate having a light scattering layer was fabricated.

Specifically, the above-prepared light scattering layer coating liquid 2 was applied to a thickness of 0.39 μm onto a surface of a display substrate, the surface being opposite to a light-emitting surface thereof. After evaporation of the solvent, the thus-applied light scattering layer (refractive index: 1.510, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Subsequently, the above-prepared high-refractive-index buffer layer coating liquid 1 was applied onto the light scattering layer to a thickness of 3.0 μm. After evaporation of the solvent, the thus-applied high-refractive-index buffer layer (refractive index: 1.620) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Through cross-sectional TEM, it was confirmed that the high-refractive-index particles were in contact with the interface between the light scattering layer and the high-refractive-index buffer layer, with being arranged almost in a row. Also, the filling rate of the light scattering layer with the high-refractive-index particles was found to be 45% by volume.

The thus-fabricated display substrate, having the light scattering layer and the high-refractive-index buffer layer, was made to closely adhere with a roller to the barrier layer of the organic EL display device of Production Example 1, to thereby fabricate an organic EL display device of Example 5.

### Example 6

### —Fabrication of Organic EL Display Device—

The procedure of Example 5 was repeated, except that the light scattering layer coating liquid 2 was applied to a thickness of 0.46 μm onto a surface of a display substrate, the surface being opposite to a light-emitting surface thereof, to thereby fabricate an organic EL display device of Example 6.

Through cross-sectional TEM, it was confirmed that the high-refractive-index particles were disposed almost in a row, and the distance of the interface between the light scattering layer and the low-refractive-index buffer layer from the closest point of each particle to the interface ranged from 0 μm to 0.07 μm. Also, the filling rate of the light scattering layer with the high-refractive-index particles was found to be 45% by volume.

### Comparative Example 5

### —Fabrication of Organic EL Display Device—

The procedure of Example 5 was repeated, except that the light scattering layer coating liquid 1 was applied to a thickness of 0.49 μm onto a surface of a display substrate, the surface being opposite to a light-emitting surface thereof, to thereby fabricate an organic EL display device of Comparative Example 5.

Through cross-sectional TEM, it was confirmed that the distance of the interface between the light scattering layer and the high-refractive-index buffer layer from the closest point of each high-refractive-index particle to the interface ranged from 0 μm to 0.12 μm. Also, the filling rate of the light scattering layer with the high-refractive-index particles was found to be 45% by volume.

### Example 7

### —Fabrication of Organic EL Display Device—

First, a display substrate having a light scattering layer was fabricated. Specifically, the above-prepared light scattering layer coating liquid 3 was applied to a thickness of 0.45 μm onto a surface of a display substrate, the surface being opposite to a light-emitting surface thereof. After evaporation of the solvent, the thus-applied light scattering layer (refractive index: 1.510, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Subsequently, the above-prepared high-refractive-index buffer layer coating liquid 1 was applied onto the light scattering layer to a thickness of 3.0 μm. After evaporation of the solvent, the thus-applied high-refractive-index buffer layer (refractive index: 1.620) was cured through irradiation of UV rays (illuminance: 400 mW/cm² and irradiation dose: 300 mJ/cm²) using a 160 W/cm air-cooled metal halide lamp (product of EYE GRAPHICS CO., LTD.). Through cross-sectional TEM, it was confirmed that the high-refractive-index particles were in contact with the interface between the light scattering layer and the high-refractive-index buffer layer, with being arranged almost in a row. Also, the filling rate of the light scattering layer with the high-refractive-index particles was found to be 45% by volume.

The thus-fabricated display substrate, having the light scattering layer and the high-refractive-index buffer layer, was made to closely adhere with a roller to the barrier layer of the organic EL display device of Production Example 1, to thereby fabricate an organic EL display device of Example 7.

### Example 8

### —Fabrication of Organic EL Display Device—

The procedure of Example 7 was repeated, except that the light scattering layer coating liquid 3 was applied to a thickness of 0.54 μm onto a surface of a display substrate, the surface being opposite to a light-emitting surface thereof, to thereby fabricate an organic EL display device of Example 8.

Through cross-sectional TEM, it was confirmed that the high-refractive-index particles were disposed almost in a row, and the distance of the interface between the light scattering layer and the low-refractive-index buffer layer from the closest point of each particle to the interface ranged from 0 μm to 0.2 μm. Also, the filling rate of the light scattering layer with the high-refractive-index particles was found to be 45% by volume.

### Comparative Example 6

### —Fabrication of Organic EL Display Device—

The procedure of Example 7 was repeated, except that the light scattering layer coating liquid 3 was applied to a thickness of 0.59 μm onto a surface of a display substrate, the surface being opposite to a light-emitting surface thereof, to thereby fabricate an organic EL display device of Comparative Example 6.

Through cross-sectional TEM, it was confirmed that the distance of the interface between the light scattering layer and the high-refractive-index buffer layer from the closest point of each high-refractive-index particle to the interface ranged from 0 μm to 0.14 μm. Also, the filling rate of the light scattering layer with the high-refractive-index particles was found to be 45% by volume.

### Example 9

### —Fabrication of Organic EL Display Device—

First, a display substrate having a light scattering layer was fabricated. Specifically, the above-prepared light scattering layer coating liquid 4 was applied to a thickness of 1.0 μm onto a surface of a display substrate, the surface being opposite to a light-emitting surface thereof. After evaporation of the solvent, the thus-applied light scattering layer (refractive index: 1.510, which was determined through measurement of a sample containing no high-refractive-index particles) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Subsequently, the above-prepared high-refractive-index buffer layer coating liquid 1 was applied onto the light scattering layer to a thickness of 3.0 μm. After evaporation of the solvent, the thus-applied high-refractive-index buffer layer (refractive index: 1.620) was cured through irradiation of UV rays (illuminance: 400 mW/cm² and irradiation dose: 300 mJ/cm²) using a 160 W/cm air-cooled metal halide lamp (product of EYE GRAPHICS CO., LTD.).

Through cross-sectional TEM, it was confirmed that the high-refractive-index particles were in contact with the interface between the light scattering layer and the high-refractive-index buffer layer, with being arranged almost in a row. Also, the filling rate of the light scattering layer with the particles was found to be 45% by volume.

The thus-fabricated display substrate, having the light scattering layer and the high-refractive-index buffer layer, was made to closely adhere with a roller to the barrier layer of the organic EL display device of Production Example 1, to thereby

### Example 10

### —Fabrication of Organic EL Display Device—

The procedure of Example 9 was repeated, except that the light scattering layer coating liquid 4 was applied to a thickness of 1.2 μm onto a surface of a display substrate, the surface being opposite to a light-emitting surface thereof, to thereby fabricate an organic EL display device of Example 10.

Through cross-sectional TEM, it was confirmed that the high-refractive-index particles were disposed almost in a row, and the distance of the interface between the light scattering layer and the low-refractive-index buffer layer from the closest point of each particle to the interface ranged from 0 μm to 0.2 μm. Also, the filling rate of the light scattering layer with the high-refractive-index particles was found to be 45% by volume.

### Comparative Example 7

### —Fabrication of Organic EL Display Device—

The procedure of Example 9 was repeated, except that the light scattering layer coating liquid 4 was applied to a thickness of 1.3 μm onto a surface of a display substrate, the surface being opposite to a light-emitting surface thereof, to thereby fabricate an organic EL display device of Comparative Example 7.

Through cross-sectional TEM, it was confirmed that the distance of the interface between the light scattering layer and the high-refractive-index buffer layer from the closest point of each high-refractive-index particle to the interface ranged from 0 μm to 0.3 μm. Also, the filling rate of the light scattering layer with the high-refractive-index particles was found to be 45% by volume.

Next, the organic EL display devices of Examples 1 to 10 and Comparative Examples 1 to 7 were evaluated for their brightness in the following manner. The results are shown in Table 1.

### <Evaluation of Brightness>

Each organic EL display device was continuously lit at a constant electric current of 2.0 mA/cm² and measured for its front brightness using a brightness meter (BM5A, product of TOPCON CORPORATION).

TABLE 1

| | | | | | | Distance of | |
|---|---|---|---|---|---|---|---|
| | High-refractive-index | | | | | high-refractive-index | |
| | particles | | Light scattering layer | | | particles from | |
| | | Avg. particle | Coating | Thickness | Refractive | interface/average | Brightness |
| | Type | diameter (μm) | liquid No. | (μm) | index | particle diameter | (cd/m²) |
| Comp. | Not | — | Not used | — | — | — | 30 |
| Ex. 1 | used | | | | | | |
| Comp. | TiO₂ | 0.39 | 1 | 3.0 | 1.44 | 7.69 | 36 |
| Ex. 2 | | | | | | | |
| Ex. 1 | TiO₂ | 0.39 | 1 | 0.39 | 1.44 | 1.00 | 45 |
| Ex. 2 | TiO₂ | 0.39 | 1 | 0.46 | 1.44 | 1.18 | 40 |
| Comp. | TiO₂ | 0.39 | 1 | 0.49 | 1.44 | 1.26 | 33 |
| Ex. 3 | | | | | | | |
| Ex. 3 | TiO₂ | 0.39 | 1 | 0.39 | 1.44 | 1.00 | 45 |
| Ex. 4 | TiO₂ | 0.39 | 1 | 0.46 | 1.44 | 1.18 | 40 |
| Comp. | TiO₂ | 0.39 | 1 | 0.49 | 1.44 | 1.26 | 33 |
| Ex. 4 | | | | | | | |
| Ex. 5 | TiO₂ | 0.39 | 2 | 0.39 | 1.51 | 1.00 | 42 |
| Ex. 6 | TiO₂ | 0.39 | 2 | 0.46 | 1.51 | 1.18 | 38 |
| Comp. | TiO₂ | 0.39 | 2 | 0.49 | 1.51 | 1.26 | 33 |
| Ex. 5 | | | | | | | |
| Ex. 7 | TiO₂ | 0.45 | 3 | 0.45 | 1.44 | 1.00 | 46 |
| Ex. 8 | TiO₂ | 0.45 | 3 | 0.54 | 1.44 | 1.20 | 41 |
| Comp. | TiO₂ | 0.45 | 3 | 0.59 | 1.44 | 1.31 | 35 |
| Ex. 6 | | | | | | | |
| Ex. 9 | TiO₂ | 1.0 | 4 | 1.0 | 1.51 | 1.00 | 42 |
| Ex. 10 | TiO₂ | 1.0 | 4 | 1.2 | 1.51 | 1.20 | 38 |
| Comp. | TiO₂ | 1.0 | 4 | 1.3 | 1.51 | 1.30 | 33 |
| Ex. 7 | | | | | | | |

The organic EL display device of the present invention exhibits improved light extraction efficiency and high brightness, and is preferably used as a bottom-emission-type or top-emission-type organic EL display device.

What is claimed is:

1. An organic EL display device comprising:
at least one high-refractive-index layer having a refractive index of 1.6 or higher, and
at least one low-refractive-index layer having a refractive index lower than 1.6,
wherein the low-refractive-index layer comprises high-refractive-index particles having a refractive index of 1.6 or higher, and
wherein the high-refractive-index particles are disposed in a region 1.0 time 10 to 1.2 times an average particle diameter of the particles from an interface between the high-refractive-index layer and the low-refractive-index layer, and the average particle diameter is 0.3 μm to 1 μm.

2. The organic EL display device according to claim 1, wherein the at least one low-refractive-index layer has a refractive index of 1.45 or lower.

3. The organic EL display device according to claim 1, wherein the at least one high-refractive-index layer is at least one selected from an anode, a cathode, a light-emitting layer, a barrier layer and a high-refractive-index buffer layer.

4. The organic EL display device according to claim 1, wherein the at least one low-refractive-index layer is at least one selected from a light scattering layer, an adhesion layer, a color filter, a glass substrate, a low-refractive-index buffer layer and an overcoat layer.

5. The organic EL display device according to claim 3, wherein the at least one high-refractive-index layer comprises the anode, the light-emitting layer, the cathode and the barrier layer, and the at least one low-refractive-index layer comprises a light scattering layer and a low-refractive-index buffer layer, wherein the light-emitting layer, the cathode, the barrier layer, the light scattering layer and the low-refractive-index buffer layer are laid on the anode in this order, and wherein the light scattering layer comprises high-refractive-index particles having a refractive index of 1.6 or higher, and the high-refractive-index particles are in contact with or disposed proximately to an interface between the barrier layer and the light scattering layer.

6. The organic EL display device according to claim 3, wherein the at least one high-refractive-index layer comprises the anode, the light-emitting layer, the cathode, the barrier layer and the high-refractive-index buffer layer, and the at least one low-refractive-index layer comprises a light scattering layer, wherein the light-emitting layer, the cathode, the barrier layer, the high-refractive-index buffer layer and the light scattering layer are laid on the anode in this order, and wherein the light scattering layer comprises high-refractive-index particles having a refractive index of 1.6 or higher, and the high-refractive-index particles are in contact with or disposed proximately to an interface between the high-refractive-index buffer layer and the light scattering layer.

7. The organic EL display device according to claim 5, wherein the light scattering layer has a thickness 1 time to 1.2 times an average particle diameter of the high-refractive-index particles.

8. The organic EL display device according to claim 1, wherein the high-refractive-index particles are at least one inorganic particles selected from TiO₂, ZrO₂, ZnO and SnO₂.
